(19) United States
(12) Patent Application Publication
(10) Pub. No.: US 2007/0121445 A1
(43) Pub. Date: May 31, 2007

(54) Optical information reproducing method

(76) Inventors: Koichiro Nishimura, Yokohama (JP); Tsuyoshi Toda, Kodaira (JP); Mitsuru Harai, Tokyo (JP); Koichi Suzuki, Hitachinaka (JP); Toru Kawashima, Mito (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/491,991

(22) Filed: Jul. 25, 2006

(30) Foreign Application Priority Data
Nov. 30, 2005 (JP) 2005-344880

(51) Int. Cl. G11B 20/10

(52) U.S. Cl. 369/47.5; 369/47.38

(57) ABSTRACT

Disclosed is a method of reproducing optical information by applying laser light to the medium while rotating a recording medium having concentric information tracks or a spiral information track so that the linear velocity of the medium is constant, and thereby reproducing the information recorded on the recording medium by the reflected light. In this method, in moving a reproduction radial position to a second radial position different from the current position, a laser power is changed to second laser power, which is different from current laser power, and then the light spot is moved to the second radial position. This method can prevent degradation of a medium in reproduction light resistance caused by substantially high power reproduction, and erasing or destruction of already recorded data that may be caused, in high-speed recording of a rewritable-type or write-once-type optical disc, when the linear velocity at the time of reproduction becomes slow, e.g. , in an access operation at the time of reproduction with a constant linear velocity and in a return operation from rotational stop due to a standby state.

### CLAIM OF PRIORITY

The present application claims priority from Japanese application serial no. JP 2005-344880, filed on Nov. 30, 2005, the content of which is hereby incorporated by reference into this application.

### BACKGROUND OF THE INVENTION

1. Field of the Invention

This invention relates to an optical information reproducing method.

2. Description of the Related Art

In such rewritable optical discs as DVD-RAM, when reproduction laser power is increased, the laser light may affect already recorded data, degrading data quality and erasing the data. In the following, this will be referred to as the degradation in reproduction light resistance. Control of the reproduction power with respect to the degradation in reproduction light resistance is explained by Japanese Patent Laid-open Publication (JP-A) Nos. 2005-228470 and 2001-176141 in details, for example.

### SUMMARY OF THE INVENTION

Improvement in the recording rates and the reproducing rates of various optical discs are being advanced in recent years. For the time of recording the DVD-RAM disc among these optical discs, the standard stipulates verification processing in which recorded data is reproduced just after recording to measure the error rate, whereby recording quality is checked. In this case, increasing the reproduction rate at the time of verification processing is effective to improve the recording rate.

Generally, it is necessary to allow for a noise band of a signal reproducing system of an optical disk about 1.5- to 2-times the reproduction signal band (carrier band). Therefore, if the white noise spreading flatly to a high band is assumed as a noise factor, there is a problem that, when the reproduction rate is increased, the noise band will increase in response to a shift of the reproduction signal band (carrier band). On the other hand, there is a problem that, when the reproduction signal amplitude (carrier amplitude) is constant, an S/N (Signal Noise Rate) that is one of indices of the reproduced signal quality will decrease by an increase of the noise band.

As a method circumventing these problems, there is a method whereby a laser power at the time of signal reproduction is increased to increase the carrier amplitude. For example, although the standard stipulates that the laser power at the time of reproduction of the DVD-RAM disc must be 1.0±0.1 mW, if this value is increased up to 2.0 mW, the carrier amplitude increases by 6 dB and the noise amplitude increases by 3 dB, and accordingly the S/N can be improved by 3 dB as compared with a case of a laser power of 1.0 mW.

Here, as methods for controlling rotation of an optical disc, there are known the CLV (Constant Linear velocity) method of rotating a disc at a constant linear velocity and the CAV (Constant Angular Velocity) method of rotating a disc at a constant angular velocity of rotation.

In the CLV method, since the linear velocity is the same all over a disc, a construction of a recording and reproducing system is relatively easy and a characteristic of a disc recording film can be designed similarly all over the disc. However, the recording and reproducing processing is done all over the disc at a linear velocity that can be attained in the innermost periphery, and therefore this method is not suitable to improvement in speed of the recording and reproducing velocity in the outer periphery of the disc.

On the other hand, the use of the CAV method can increase the linear velocity in the outermost periphery about 2.5 times higher than the linear velocity of the innermost periphery in an optical disc with a diameter of 120 mm, and this method makes it easy to improve the recording rate and the reproducing rate, especially in the outer periphery part of the disc.

In the case of an optical disc recording and reproducing device compatible to high-speed recording, normally high-speed recording/reproducing by the CAV method is performed. However, when compatibility with the conventional device only supporting the CLV recording method is considered, the optical disc device of the CAV method is required to support the CLV recording method at a minimum linear velocity used at the time of the CAV method.

However, if the S/N is improved by increasing reproduction power, the following problem will occur.
1. Reproduction with Excessive Power by the CLV Method

In the reproduction by rotation control of the CLV method, the rotational velocity becomes slower with increasing radial position toward the outer periphery, as shown by a solid line 201 in FIG. 2. For example, consider a case of conducting reproduction by random access as in the case where the reproduction radial position is moved to the innermost periphery from the outermost periphery. In this case, if a movement time of the pickup head is shorter than a stabilization time of change of the rotational velocity, the rotational velocity of the pickup head just after moving to the inner periphery becomes 1/2.5 times (3920 rpm) the rotational velocity that is required in the innermost periphery (9800 rpm). For this reason, if the pickup head is moved with the reproduction power of the laser in the outermost periphery being maintained, the reproduction power in the innermost periphery becomes equivalent to 2.5 times that of the outermost periphery. Consequently, the degradation in reproduction light resistance of a recorded type optical disc occurs, and the possibility that the recorded data is erased will arise.
2. Return Operation from Rotational Stop State

There are many optical disc recording/reproducing devices that, when no command access from a host is made for a certain period, normally move to a standby state in which rotation of a disc is stopped in order to curtail power consumption. In particular, with an optical disc recording/reproducing device that is mounted on a note PC, a portable AV apparatus, etc. each of which has a premise of battery driving, a standby function becomes an essential function. When the rotation of the disc is restored to the normal rotational velocity, if the laser power is set to a normal reproduction power before the rotational velocity reaches a desired velocity, and if the rotational velocity is slow, the reproduction power is excessive, the degradation in reproduction light resistance occurs, and it is likely that erasing of the recorded data occurs. In particular, in the case of high-speed reproduction, since a time that is required for the disc in a rotational stop state to stabilize in a desired rotational velocity becomes large, the degradation in reproduction light resistance becomes a larger problem.

To address these problems, the present invention aims at providing, in high-speed reproduction of recording media of the rewritable type and of the write-once read-many type, an optical information reproducing method for preventing the degradation in reproduction light resistance resulting from reproduction at a low linear velocity and erasing/destruction of the already recorded data both in random access reproduction based on the CLV method and in reproduction start from the rotational stop state.

A first aspect of this invention is directed to a method of reproducing optical information in which laser light is applied to a recording medium having an information track capable of recording information thereon, and the recorded information on the recording medium is reproduced by the reflected light, wherein: when the rotational velocity of the recording medium is changed from a first rotational velocity to a second rotational velocity, a radial position is moved to a predetermined radial position while first laser power is being maintained and the rotational velocity is being kept to the first rotational velocity as it is; and the laser power is changed to second laser power and also the rotational velocity is changed to the second rotational velocity.

A second aspect of this invention is directed to a method of reproducing optical information in which laser light is applied to a recording medium having an information track capable of recording information thereon, and the recorded information on the recording medium is reproduced by the reflected light, wherein: when the rotational velocity of the recording medium is changed, at a predetermined radial position, from a first rotational velocity to a second rotational velocity, first laser power during the change of the rotational velocity from the first rotational velocity to the second rotational velocity is different from second laser power after the rotational velocity reaches to the second rotational velocity.

A third aspect of this invention is directed to a method of reproducing optical information in which laser light is applied to a recording medium having an information track capable of recording information thereon, and the recorded information on the recording medium is reproduced by the reflected light, wherein: when an light spot is moved to be formed on the medium by a laser from a first radial position, which is a current radial position, to a second radial position, the laser power is changed from first laser power, which is a current laser power, to second laser power; and the light spot is moved to the second radial position.

A fourth aspect of this invention is directed to a method of reproducing optical information in which laser light is applied to a recording medium having an information track capable of recording information thereon while the medium is being rotated so as to have a constant linear velocity, and the recorded information on the recording medium is reproduced by the reflected light, wherein: when the light spot to be formed on the medium is moved by a laser from a first radial position, which is a current radial position, to a second radial position, a first laser power, which is a current laser power, is changed to a second laser power, and then the light spot is moved to the second radial position.

### BRIEF DESCRIPTION OF THE DRAWINGS

Embodiments of the present invention will be described in detail based on the following figures, wherein:

FIG. 1 is a diagram showing one example of a configuration of an optical disc reproducing device according to an embodiment of this invention;

FIG. 2 is a diagram showing a relation between a radial position and a rotational velocity at the time of 6 times velocity CLV control;

FIG. 3 is a processing flowchart at the time of canceling the standby in a fifth embodiment;

FIGS. 4A, 4B, 4C, 4D, and 4E are schematic diagrams showing one example of a pickup radial position, reproduction power, a disc angular velocity of rotation, a reproduction linear velocity, and reproduction power per unit length (reproduction power density) versus time at the time of access, respectively;

FIG. 5 is a processing flowchart at the time of access in a first embodiment;

FIGS. 6A, 6B, 6C, 6D, and 6E are schematic diagrams showing one example of relations of the pickup radial position, the reproduction power, the disc angular velocity of rotation, the reproduction power per unit length (the reproduction power density) versus time at the time of access, respectively, in the first embodiment;

FIGS. 7A, 7B, 7C, 7D, and 7E are schematic diagrams showing one example of relations of the pickup radial position, the reproduction power, the disc angular velocity of rotation, the reproduction linear velocity, and the reproduction power per unit length (the reproduction power density) versus time at the time of canceling the standby, respectively, in the conventional optical disc device;

FIG. 8 is a processing flowchart at the time of canceling the standby in a second embodiment;

FIG. 9 is a processing flowchart at the time of canceling the standby in a third embodiment;

FIG. 10 is a schematic diagram showing one example of relations of the pickup radial position, the reproduction power, the disc angular velocity of rotation, the reproduction linear velocity, and the reproduction power per unit length (the reproduction power density) versus time at the time of canceling the standby in the third embodiment;

FIG. 11 is a schematic diagram showing one example of relations of the pickup radial position, the reproduction power, the disc angular velocity of rotation, the reproduction linear velocity, and the reproduction power per unit length (the reproduction power density) versus time at the time of canceling the standby in the second embodiment; and

FIG. 12 is a processing flowchart at the time of access in a fourth embodiment.

### DETAILED DESCRIPTION OF THE PREFERRED EMBODIMENTS

Embodiments of this invention will be described below.

### First Embodiment

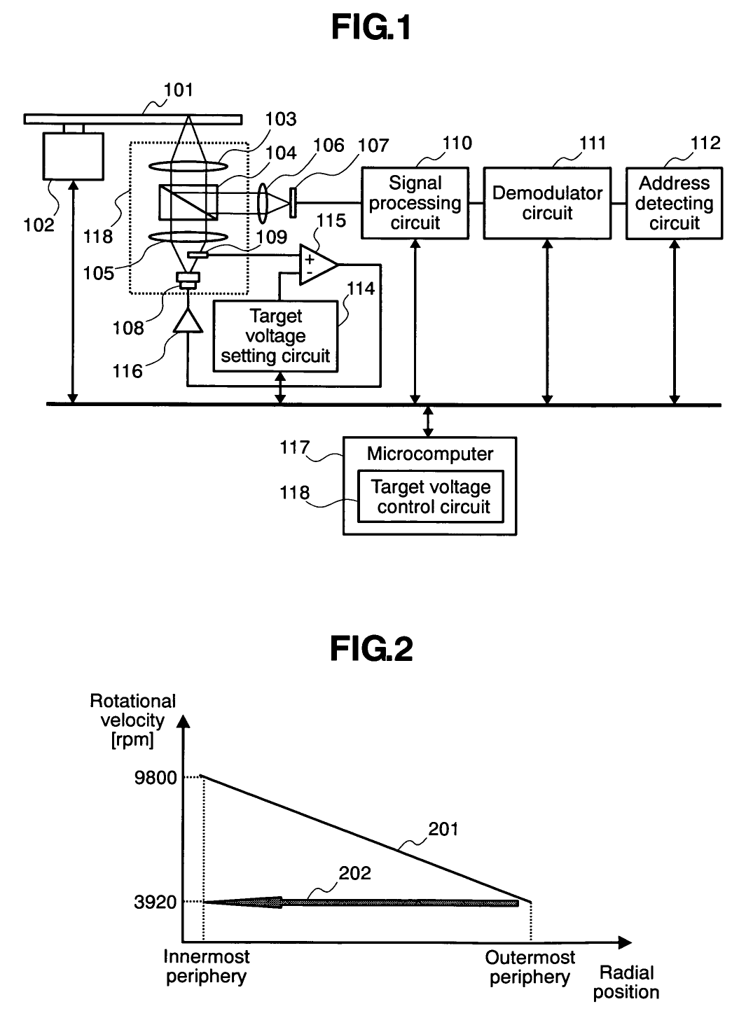

FIG. 1 shows a configuration of an optical disc reproducing device of a first embodiment. In this FIG. 1, laser light emitted from a laser 108 passes through a collimator lens 105 and an objective lens 103 and is irradiated onto a predetermined radial position on a recording medium 101. Reflected light from the recording medium 101 passes through a beam splitter 104, is converged by a converging lens 106, and converted to an electric signal (hereinafter referred to as the signal) bya photoelectric transducer 107. The obtained signal is decoded through a signal processing circuit 110 and a demodulator circuit 111, and inputted into an address detector circuit 112. The laser power emitted from the laser 108 is controlled by detecting a difference between the signal voltage obtained by a front monitor 109 in the optical path and the target voltage outputted from a target voltage setting circuit 114 with a difference detection circuit 115 and returning it to the laser through an amplifier 116.

A reference numeral 117 denotes a microcomputer for controlling a spindle motor 102, the signal processing circuit 110, the demodulator circuit 111, and the address detector circuit 112. A target voltage setting circuit 118 built in the microcomputer 117 controls the target voltage setting circuit 114 based on information from the spindle motor 102, the address detector circuit 112, etc.

FIG. 2 is a diagram showing a relation between the radial position at the time of 6 times CLV control and the rotational velocity in an optical disc of a diameter of 120 mm. In the CLV rotation control, for example, in the case where the 6 times velocity is realized with a rotational velocity of the innermost periphery of 9800 rpm, as with the DVD-RAM, a rotation velocity of 9800 rpm becomes necessary in the innermost periphery and a rotational velocity of 3920 rpm becomes sufficient in the outermost periphery, as shown by a straight line 201 of FIG. 2. That is, 1/2.5 times the rotational velocity of the innermost periphery will be sufficient for the rotational velocity of the outermost periphery. That is, if the pickup head is moved to the innermost periphery while the rotational velocity of the outermost periphery is being maintained, the linear velocity of the innermost periphery becomes 2.4 times the linear velocity that is 1/2.5 times the 6 times linear velocity.

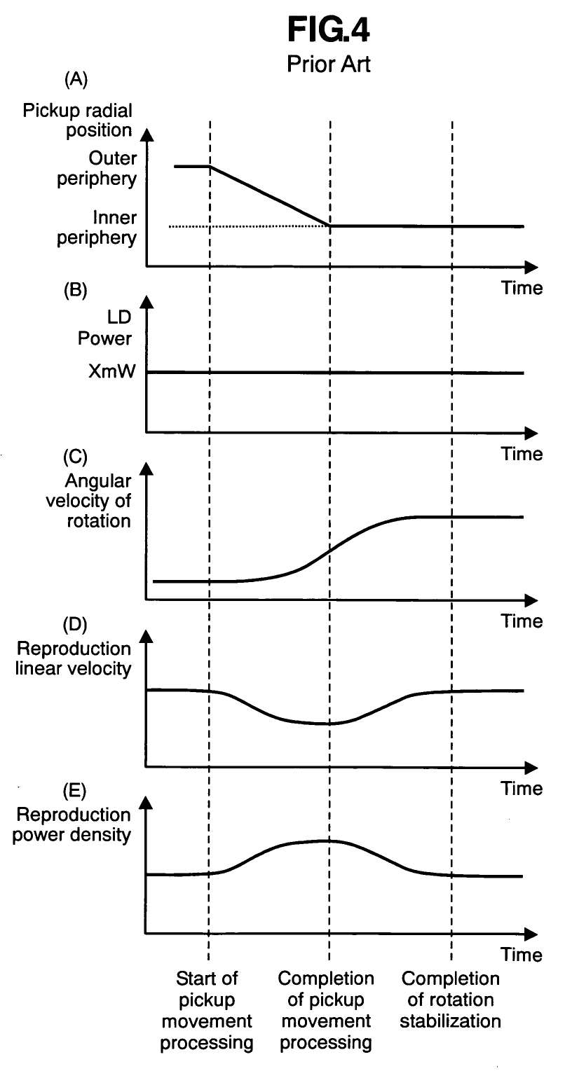

FIGS. 4A, 4B, 4C, 4D, and 4E show a pickup radial position, reproduction power, a disc angular velocity of rotation, and reproduction power per unit length (reproduction power density), respectively, in this processing time. As shown in the figure, when a change of the disc angular velocity of rotation is slow (FIG. 4C) as compared with the movement time for the pickup to move from the outer periphery to the inner periphery (FIG. 4A), a reproduction linear velocity decreases at some midpoint during the processing time, as shown in FIG. 4D. Therefore, when the reproduction power is constant, as shown in FIG. 4B, the reproduction power per unit time increases in a region where the reproduction linear velocity decreases, as shown in FIG. 4E, and the degradation in reproduction light resistance or the erasing of data is likely to occur.

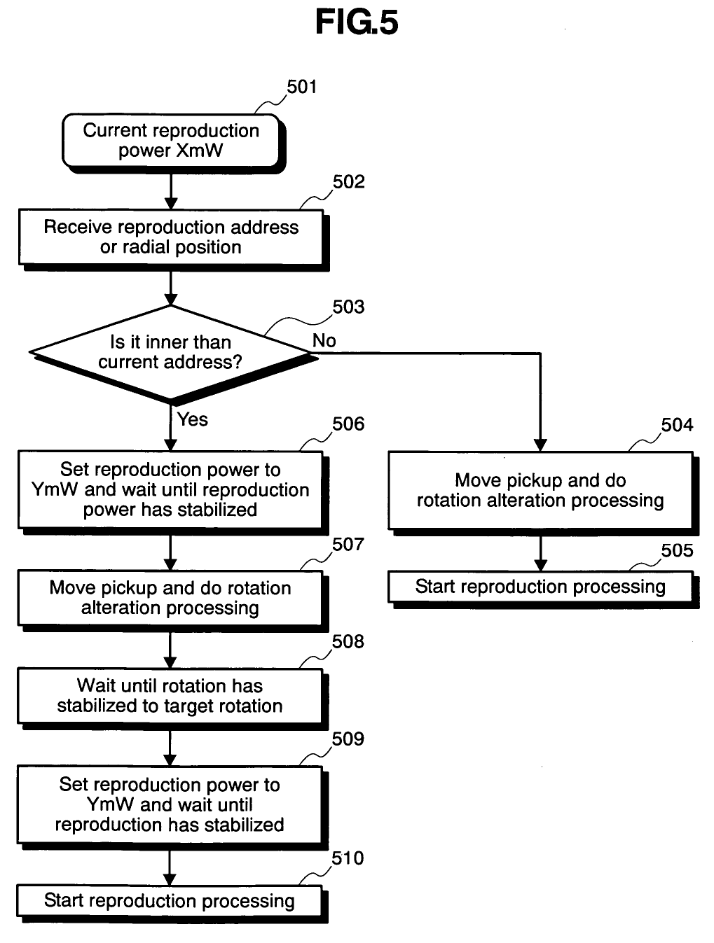

Therefore, in the first embodiment of this invention, the pickup head is moved through a sequence shown in FIG. 5. The sequence of this FIG. 5 will be explained in detail below.
1. In setting current laser power to X mW (Step 501), an address or radial position information of a movement destination is acquired (Step 502).
2. It is determined whether the movement destination is inner than the current reproduction position in terms of radius (Step 503).
3. If the radial position is located on the outer side, movement processing of the pickup head and rotational velocity alteration processing are conducted while the reproduction laser power is being kept, and a reproduction operation is started (Steps 504, 505).
4. If the radial position is located on the inner side, the reproduction laser power is changed to Y mW (Y<X) by altering the setting of the target voltage setting circuit 114, and stabilization of the laser power is monitored by the microcomputer 117 or the like (Step 506).
5. When the change of the reproduction laser power is completed, movement processing of the pickup head and the alteration processing of the rotational velocity are conducted (Step 507).
6. Stabilization of the rotational velocity at the movement destination is checked (Step 508). When the rotational velocity has reached the target value, the setting of the target voltage setting circuit 114 is altered, the reproduction laser power is restored to X mW, and the stabilization of the reproduction laser power is monitored by the microcomputer 117 or the like (Step 509).
7. When the change of the reproduction laser power is completed, the reproduction operation is started (Step 510).

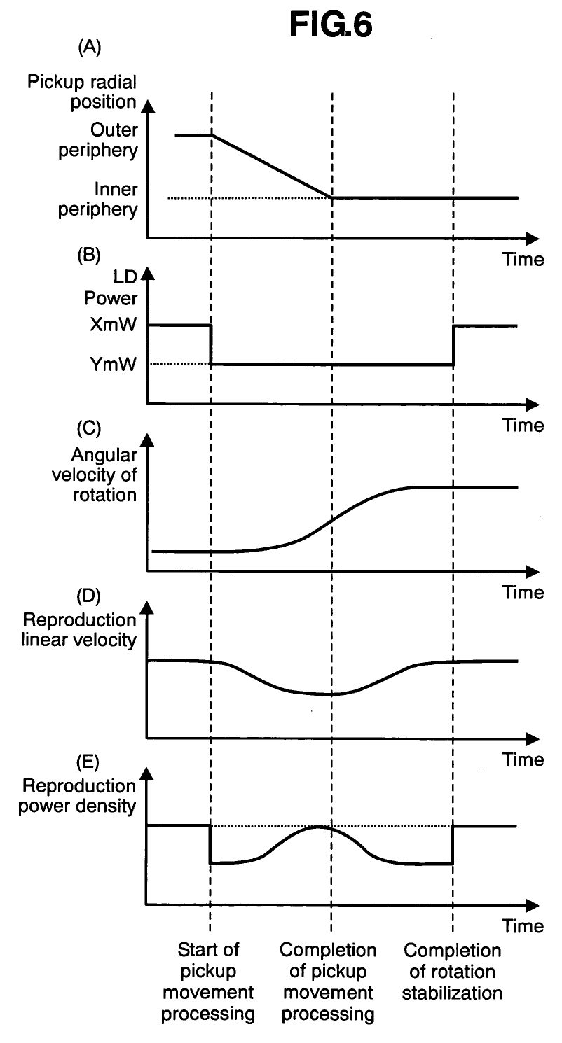

FIGS. 6A, 6B, 6C, 6D, and 6E show the pickup radial position, the reproduction power, the disc angular velocity of rotation, the reproduction linear velocity, and the reproduction power per unit length (the reproduction power density), respectively, in the processing time when the processing runs. As shown in FIG. 6B, the reproduction power in the time from movement start of the pickup to completion of stabilization of the rotation is lowered to Y mW from X mW, whereby the reproduction power per unit time is made not to exceed the reproduction power per unit time at the time of normal reproduction, as shown in FIG. 6E, and therefore the degradation in reproduction light resistance and erasing of already recorded data can be prevented.

In addition, both in waiting stabilization of rotation and in the waiting stabilization of the reproduction power in the above-mentioned sequence, radial position information acquiring processing by address acquisition etc. for the reproduction operation and subsequent reproduction processing may be started.

In the sequence, it is allowed that a relation between the reproduction laser power X and the reproduction power Y is set to not less than 2 mW and 1 mW±10%, or not less than 2 mW and 0.7 mW. Moreover, the reproduction power Y may be changed depending on a radial position of a moving target position or may be set to a fixed value. The use of these reproduction values makes it possible to perform suitable reproduction of the DVD-RAM disc.

### Second Embodiment

Next, a second embodiment of this invention will be explained. A configuration of an optical disc reproducing device of the second embodiment is the same as the configuration of the optical disc reproducing device of the first embodiment, and accordingly detailed explanation will be omitted.

In the optical disc reproducing device, in order to curtail power consumption, there has hitherto been conducted standby processing in which, when no command access was made for a constant time, the rotational velocity of a recording medium is lowered or stooped. Then, in the conventional optical disc reproducing device, when a standby state is cancelled by a command from a host or the like, the laser is oscillated to emit light at the reproduction power to perform reproduction start processing immediately after rotation start of a medium.

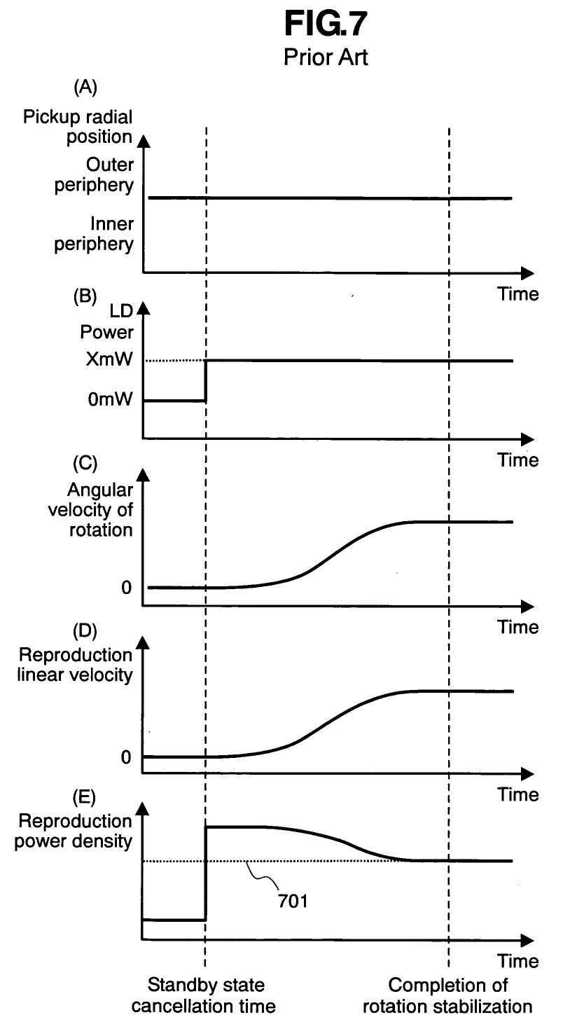

First, the pickup radial position, the reproduction power, the disc angular velocity of rotation, the reproduction linear velocity, and the reproduction power per unit length (the reproduction power density) will be explained using FIGS. 7A-7E. As shown in this FIG. 7B, if the normal laser reproduction power X mW is supplied upon cancellation of the standby state, the reproduction linear velocity remains low, as shown in this FIG. 7D, for a period until the angular velocity of rotation of this FIG. 7C has stabilized. For this reason, a period when the reproduction power per unit time exceeds the reproduction power 701 per unit time at the time of the normal reproduction, as shown in this FIG. 7E, occurs and the degradation in reproduction light resistance or erasing of the recorded data is likely to occur in that region.

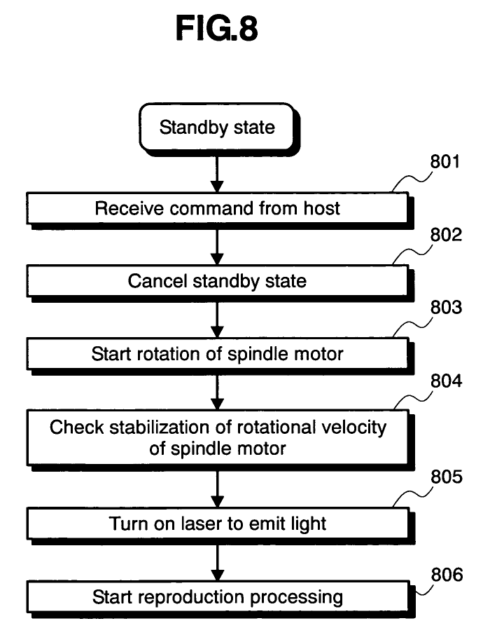

A reproduction state sequence for circumventing such a problem will be explained using FIG. 8.
1. In the standby state, a command from the host is received (Step 801).
2. The standby state is cancelled (Step 802) and rotation of the spindle motor 102 is started (Step 803). However, the laser is not oscillated to emit light at this time.
3. The microcomputer 117 or the like measures a rotation period of the spindle motor 102 to check whether the rotation period has stabilized to the target value (Step 804).
4. After checking the stabilization of the rotational velocity of the spindle motor to the target value, the laser is oscillated to emit light of the reproduction power (Step 805), and the reproduction processing is started (Step 806).

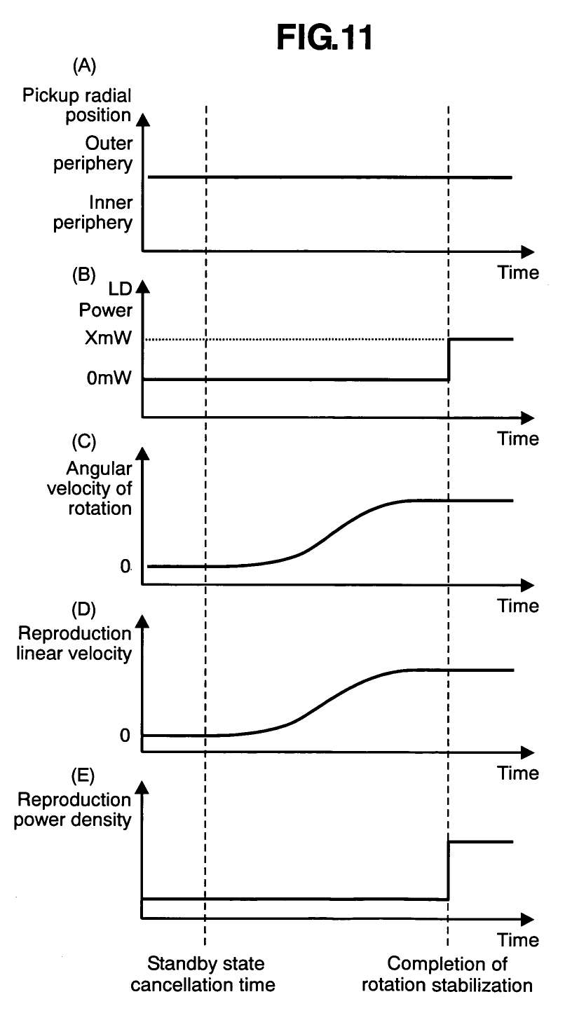

FIGS. 11A, 11B, 11C, 11D, and 11E show the pickup radial position, the reproduction power, the disc angular velocity of rotation, the reproduction linear velocity, and the reproduction power per unit length (the reproduction power density), respectively, in the processing time when the above-mentioned sequence runs. By setting the reproduction power to X mW, after rotation stabilization, that is the normal reproduction power, as shown in FIG. 11B, it is possible to negate a time when the reproduction power per unit time in FIG. 11E exceeds the reproduction power 701 per unit time at the time of the normal reproduction, where by boththe degradation in reproduction light resistance and the erasing of the already recorded data can be prevented.

### Third Embodiment

Next, a third embodiment of this invention will be explained. A configuration of an optical disc reproducing device of the third embodiment is the same as the configuration of the optical disc reproducing device of the first embodiment, and accordingly detailed explanation will be omitted.

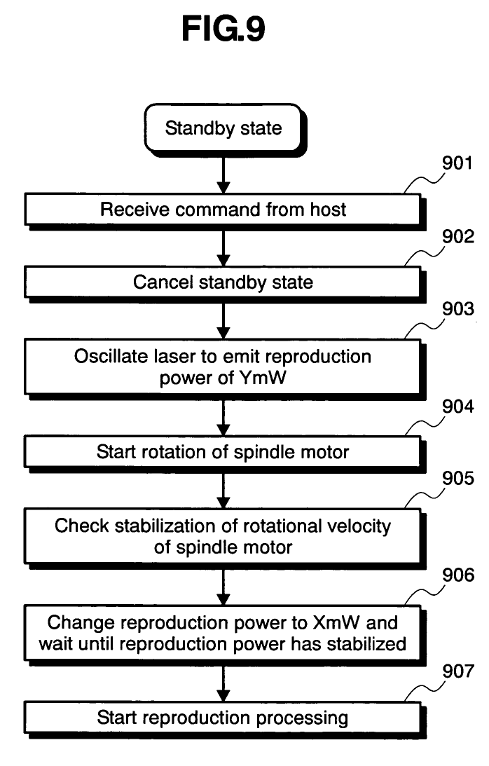

A reproduction start processing sequence in the case where the standby state is cancelled by a command etc. from the host, like the second embodiment of this invention, will be explained using FIG. 9. The reproduction laser power in this embodiment is designated by X mW.
1. In the standby state, the device receives a command for the host (Step 901).
2. The standby state is cancelled (Step 902). A laser is oscillated to emit light at reproduction laser power of Y mW that will be Y<X (Step 903) after a lapse of a fixed time, and the spindle motor 102 starts to be rotated (Step 904).
3. A rotation cycle of the spindle motor 102 is measured by the microcomputer 117 etc., and it is checked whether the rotation cycle has stabilized to a target value (Step 905).
4. After checking that the rotation period of the spindle motor has stabilized to the target value, the reproduction power of the laser is changed to X mW that is the normal reproduction laser power and stabilization of the power is waited (Step 906).
5. When the reproduction laser power has stabilized, the reproduction processing is started (Step 907).

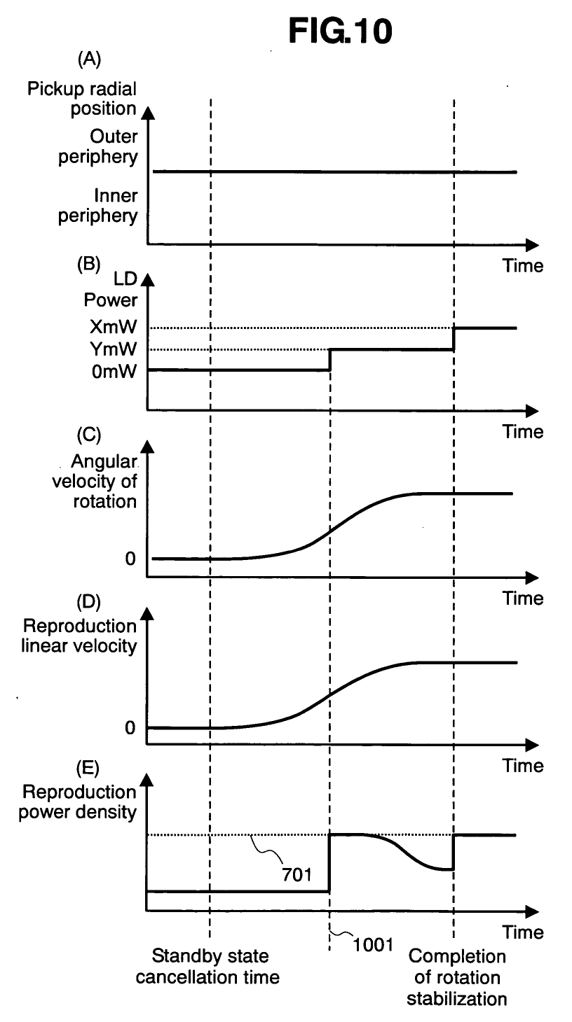

FIGS. 10A, 10B, 10C, 10D, and 10E show the pickup radial position, the reproduction power, the disc angular velocity of rotation, the reproduction linear velocity, and the reproduction power per unit length (the reproduction power density), respectively, in a processing time when the above-mentioned sequence runs. As shown in this FIG. 10B, the reproduction laser power is increased stepwise as follows: the laser power in the period from cancellation of the standby state to a time 1001 is set to 0 mW; the laser power in a period after the time 1001 to completion of rotation stabilization is set to Y mW; and the reproduction laser power is increased stepwise so that, after rotation stabilization, the laser power is set to X mW. By this setting, the reproduction power per unit time is prevented from exceeding the reproduction power 701 per unit time at the time of the normal reproduction, as shown in this FIG. 10E, and therefore the degradation in reproduction light resistance and erasing of the recorded data can be prevented.

Alternatively, the reproduction processing by the above-mentioned sequence may be started at a time when the laser power is lower than the power at the time of the normal reproduction. Further alternatively, depending on the reproduction light resistance of a disc, the time 1001 when the reproduction is started at the Y mW maybe set to zero, and the laser is oscillated to emit light just after the start of rotation. Moreover, although the alteration of the reproduction power was done in two stages in the example, the alteration may be divided into more pieces of stages than two and the reproduction power is changed in each stage.

According to the optical disc reproducing device of this embodiment, in addition to the effect attained by the optical disc reproducing device of the second embodiment, data the reproduction processing can be conducted before the rotational velocity has stabilized, and therefore an effect that reproduction start time is allowed to be set earlier can be obtained.

### Fourth Embodiment

Next, a fourth embodiment of this invention will be described. A configuration of an optical disc reproducing device of the fourth embodiment is the same as the configuration of the optical disc reproducing device of the first embodiment, and accordingly detailed explanation will be omitted. In this embodiment, like the first embodiment of this invention, the signal reproduction processing at the time of access by pickup head movement in the direction of the inner periphery from the outer periphery in the CLV rotation control will be explained taking reproduction control in the DVD-RAM disc as an example.

The DVD-RAM disc has a recordable region 1101 in which data can be written and a non-recordable region 1102. The region 1102 includes an embossed region in which disc inherent information etc. is recorded with embosses (pits), a mirror region for separating the writable region and the non-recordable region, etc. In this portion, like the DVD-ROM disc, data cannot be rewritten, and there is no possibility therein that data may be erased even if the reproduction laser power is increased.

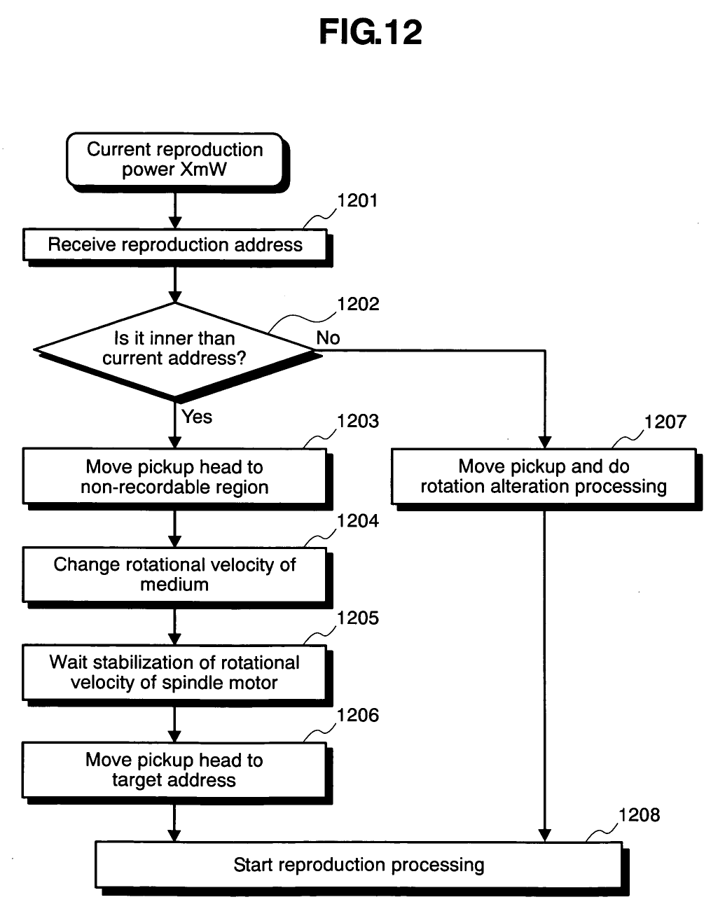

FIG. 12 shows a processing sequence at the time of access in this embodiment. Each process step of the sequence in FIG. 12 will be explained below.
1. An address of movement destination or radial position information is acquired (Step 1201).
2. It is determined whether the movement destination is inner than the current reproduction position in terms of radius (Step 1202).
3. When the movement destination is determined to be outer, pickup head movement processing and disc rotational velocity alteration processing (Step 1207) are conducted and after completion of the processing the reproduction processing operation is started (Step 1208).
4. When the movement destination is determined to be inner, the pickup head is moved to the above-mentioned non-recordable region (Step 1203) and the rotational velocity of a medium is changed to a rotational velocity corresponding to the linear velocity of the movement destination (Step 1204).
5. After checking the stabilization of the rotational velocity after alteration (Step 1205), the pickup head is moved to a moving target (Step 1206).
6. After completion of the movement processing, the reproduction processing operation is started (Step 1208).

Through the processing by the above-mentioned sequence, in the signal reproduction processing at the time of access of moving from the outer periphery to the inner periphery in the CLV rotation control, both the degradation in reproduction light resistance and erasing of the already recorded data can be prevented without changing the reproduction laser power.

According to this embodiment, since there is no alteration in the reproduction laser power, gain allocation of a servo system, such as a focus tracking servo, and offset setting do not need to be altered. Further, since it is not necessary to wait the stabilization of the laser power, the reproduction can be started earlier than the first embodiment of this invention.

### Fifth Embodiment

Next, a fifth embodiment of this invention will be described. A configuration of an optical disc reproducing device of the fifth embodiment is the same as the configuration of the optical disc reproducing device of the first embodiment, and accordingly detailed explanation will be omitted. The fifth embodiment is, like the fourth embodiment, is an embodiment in which the non-recordable region is used for a processing sequence in the case where the standby state is cancelled by a command from the host etc. in the optical disc reproducing device in which the standby state is settable.

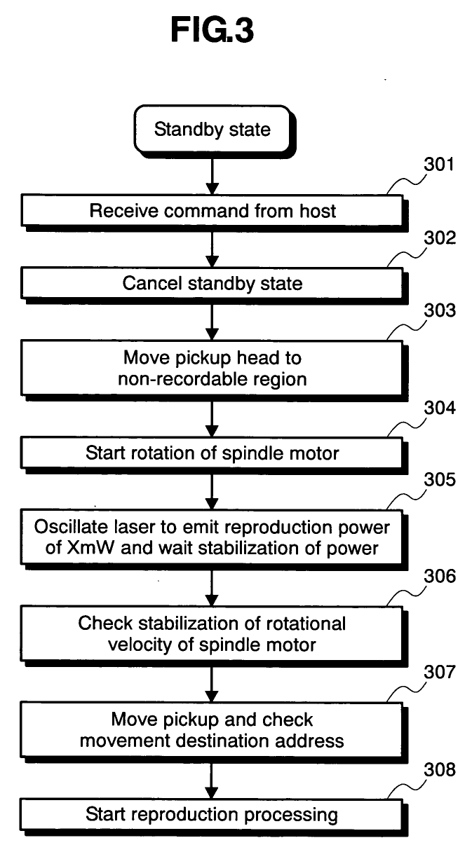

FIG. 3 shows a processing sequence at the time of access of this embodiment. Each process step of the sequence in FIG. 3 will be explained.
1. A command from the host is received in the standby state (Step 301).
2. The standby state is cancelled (Step 302), the pickup head is moved to the non-recordable region (Step 303), and rotation of the spindle motor is started (Step 304).
3. The laser is oscillated to emit light of the same X mW as at the time of the normal reproduction, and stabilization of the emitted light power is checked (Step 305).
4. The rotation period is measured by the microcomputer 117 or the like to check whether the rotation period has stabilized at the target value (Step 306).
5. After checking the stabilization of the rotational velocity of the spindle motor, the pickup head is moved to the moving target (Step 307).
6. After completion of the movement processing, the reproduction processing operation is started (Step 308).

Through the processing by the above-mentioned sequence, when the standby state is cancelled by a command from the host in the optical disc reproducing device in which the standby state is settable or by the like, both the degradation in reproduction light resistance and the erasing of the already recorded data can be prevented without changing the reproduction laser power. Moreover, since there is no change of the reproduction laser power as compared with the second and third embodiments of this invention, it is not necessary to wait stabilization at the time of change of the laser power, and accordingly the reproduction processing can be started earlier than these embodiments.

The foregoing invention has been described in terms of preferred embodiments. However, those skilled, in the art will recognize that many variations of such embodiments exist. Such variations are intended to be within the scope of the present invention and the appended claims.

What is claimed is:

1. A method of reproducing optical information in which laser light is applied to a recording medium having an information track capable of recording information thereon, and the recorded information on the recording medium is reproduced by the reflected light, the method comprising:
in changing the rotational velocity of the recording medium from a first rotational velocity to a second rotational velocity,
moving a radial position to a predetermined radial position while first laser power is being maintained and the rotational velocity is being kept to the first rotational velocity as it is; and
changing the laser power to second laser power and also changing the rotational velocity to the second rotational velocity.

2. A method of reproducing optical information in which laser light is applied to a recording medium having an information track capable of recording information thereon, and the recorded information on the recording medium is reproduced by the reflected light, wherein
in changing the rotational velocity of the recording medium, at a predetermined radial position, from a first rotational velocity to a second rotational velocity,
first laser power during the change of the rotational velocity from the first rotational velocity to the second rotational velocity is different from second laser power after the rotational velocity reaches to the second rotational velocity.

3. The method according to either claim 1 or claim 2, wherein
the first rotational velocity is zero showing a rotational stop state.

4. The method according to claim 1, wherein
the predetermined radial position is a position in the data non-recordable region provided on the recording medium.

5. A method of reproducing optical information in which laser light is applied to a recording medium having an information track capable of recording information thereon, and the recorded information on the recording medium is reproduced by the reflected light, the method comprising:
in moving an light spot to be formed on the medium by a laser from a first radial position, which is a current radial position, to a second radial position,
changing the laser power from first laser power, which is a current laser power, to second laser power; and
moving the light spot to the second radial position.

6. A method of reproducing optical information in which laser light is applied to a recording medium having an information track capable of recording information thereon while the medium is being rotated so as to have a constant linear velocity, and the recorded information on the recording medium is reproduced by the reflected light, the method comprising:
in moving the light spot to be formed on the medium by a laser from a first radial position, which is a current radial position, to a second radial position,
changing from a first laser power, which is a current laser power, to a second laser power; and
moving the light spot to the second radial position.

7. The method according to either claim 5 or claim 6, wherein
R1 and R2 satisfies the equation: R1>R2
where R1 designates a radius of the first radial position, and R2 designates a radius of the second radial position.

8. The method according to either claim 5 or claim 6, wherein
the laser power is restored to the first laser power after the spot is moved to the second radial position.
